(19) United States
(12) Patent Application Publication
(10) Pub. No.: US 2023/0094994 A1
(43) Pub. Date: Mar. 30, 2023

(54) Imaging Method, Sensor, 3D Shape Reconstruction Method and System

(71) Applicant: Congying SUI, HONG KONG (HK)

(72) Inventors: Yunhui LIU, Hong Kong (HK); Congying SUI, Hong Kong (HK)

(21) Appl. No.: 17/538,542

(22) Filed: Nov. 30, 2021

(30) Foreign Application Priority Data
Sep. 29, 2021 (HK) 32021039700.8

(51) Int. Cl. H04N 5/3745; H04N 5/341; G06T 17/00

(52) U.S. Cl. CPC H04N 5/37455; H04N 5/37452; H04N 5/341; G06T 17/00

(57) ABSTRACT

This disclosure presents a novel smart complementary metal oxide semiconductor (CMOS) sensor that can detect the “bright” pixels and export the light intensity and location of the selected pixels only. The detecting function is achieved by applying a thresholding criteria method. A novel CMOS architecture is proposed. The FPA-implemented COMS is shared by two sets of column processing circuitry for selecting, processing and exporting the data from top half and bottom half of FPA respectively. The CMOS architecture comprises a re-routing scheme, multiple I/Os deployment, parallel-shifting FIFO memory buffers, and interleaved timing scheme.

### CROSS-REFERENCE TO RELATED APPLICATIONS

This application claims priority to HONGKONG Patent Application No. 32021039700.8 with a filing date of Sep. 29, 2021. The content of the aforementioned application, including any intervening amendments thereto, are incorporated herein by reference.

### TECHNICAL FIELD

The present disclosure generally relates to the fields of smart complementary metal oxide semiconductor (CMOS) image sensors and 3D measurements and/or reconstructions. More particularly, the disclosure relates to an imaging method, an image sensor, 3D shape reconstruction method and an imaging system.

### BACKGROUND

Traditional image sensors output the whole images, which may contain many useless information. For example, in a 3D laser scanner, when a laser line sweeps across the captured objects, the desired information is the location of the bright pixels and their intensities, while the dark pixels shall not be further processed and calculated. In this case, outputting the intensities of dark pixels will lead to high bandwidth requirement and low readout speed of the sensors.

To solve this problem, we propose an imaging method and a novel smart CMOS image sensor that reduce the output bandwidth requirements and speed up the Analog Digital Converter (ADC) and a method and system for reconstructing 3D information of objects using the high-speed smart CMOS imaging sensor according to the present disclosure and structured lights.

### SUMMARY

One aspect of the disclosure provides an imaging method with pixel selection. The method includes: from one or more pixels, selecting pixels according to rules; outputting the locations or locations and intensities of the selected pixels only; exporting the data through parallel I/Os; and facilitating data exporting by a fast exporting architecture.

Implementations of the disclosure may include one or more of the following optional features. In some implementations, before outputting the selected pixels, the method further comprising at least one or more of: converting the intensities of the selected pixels to digital signals by Analog Digital Converter (ADC); in case of facilitating data exporting, re-routing the selected pixels on a row by distributing data of the selected pixels into unities; and storing, in a memory buffer, the data of the selected pixels.

In some implementations, outputting the selected pixels comprising at least one or more of: exporting the data from one or more columns by a parallel I/O, wherein in a case that the selected pixels are re-routed, the intensities of the selected pixels in a unity are outputted via an I/O channel of the parallel I/Os; and the location of the selected pixel is the code of the column in one parallel I/O; and outputting a global flag indicating one or more of the following: the number of selected pixels to be exported through the parallel I/O, or whether there is selected pixel to be exported, or the working mode of the data exportation. In some implementations, wherein selecting pixels according to at least any one of rules: the intensity of a pixel is larger than a threshold; or the intensity difference of a pixel with the pixel in its neighbouring column is larger than a threshold, wherein the threshold is set as a user-defined value, or an intensity when a light source related to the one or more pixels is off, or an average intensity of all pixels in a region when the light source is off, wherein the region is one of: a row; or a column; or an image.

In some implementations, wherein re-routing the selected pixels on a row by distributing data of the selected pixels into unities comprising: breaking up data of connected selected wise pixels in a row into one or more unities; and evenly distributing the broken up data of selected wise pixels to one or more parallel I/Os for data exportation.

In some implementations, wherein converting the intensities of the selected pixels to digital signals by ADC comprising at least one or more of: for each pixel of the one or more pixels: generating a flag related to the pixel; setting the flag to be active if the pixel is selected, or setting the flag to be non-active if the pixel is not selected; converting the intensity of the pixel to digital signals in the case that the flag related to the pixel is active; and AD converting the data corresponding to one parallel I/O simultaneously by one or more of parallel ADCs; and outputting, by a parallel ADC, one-bit digital data every cycle until the data is completely converted to digital data, and n parallel AD conversion devices outputs n bits of digital data simultaneously every cycle until the data are completely converted to digital data.

In some implementations, in a case that the ADC is an SAR (Successive Approximation Register) ADC, further comprising: selecting pixels from the one or more pixels and converting to digital signals by the SAR ADC at the same time. In some implementations, wherein AD converting and data communication use interleaved timing: when the ADC is operating a data, the data in the next row starts to be read out.

In some implementations, wherein storing in a memory buffer the data of the selected pixels comprising at least one or more of: pushing the data of the pixels corresponding to an I/O to one or more memory buffers, wherein the number of memory buffers is less than the number of pixels corresponding to a same I/O; and/or pushing the data of the selected pixels into buffers through a CLA logic-based controller; in case of a FIFO memory, shifting in/out the data one-bit-by-one-bit; and/or in case of a FIFO memory, shifting in/out a batch of multiple-bit data in parallel; and emptying the data in the memory buffer when the next intensity is being converted to digital data. In some implementations, the method further comprising controlling the operation timing by clock signals, and wherein removing signal latency by adding buffers; the buffers are in an hierarchical architecture.

Another aspect of the disclosure provides an image sensor. In some implementations, the image sensor comprises: one or more wise pixels in pixel array; a pixel-selection circuitry coupled with the pixel array, configured to select wise pixels according to rules; one or more parallel I/Os coupled with the pixel-selection circuitry, configured to output the locations or locations and intensities of the selected wise pixels; and a fast exporting architecture coupled with the parallel I/Os, configured to facilitate data exporting.

In some implementations, the image sensor further comprises at least one or more of: one or more Analog Digital Converters(ADCs) coupled with the pixel-selection circuitry, configured to convert intensities of the selected pixels to digital signals; one or more re-routing circuitries in the fast exporting architecture, configured re-route the selected wise pixels; one or more memory buffers coupled with the one or more parallel I/Os, configured to store the selected pixels before outputting by the one or more parallel I/Os; one or more column processing circuitries comprising the pixel-selection circuitry, the one or more parallel I/Os and the fast exporting architecture, wherein the pixels of one or multiple or all rows in a column are operated using a common column processing circuitry.

In some implementations, wherein the parallel I/Os further comprising at least one of: a parallel I/O, configured to export the data from one or more columns, and wherein in a case that the selected pixels are re-routed, the intensities of the selected pixels in a unity are outputted via an I/O channel of the parallel I/Os; and the location of the selected pixel is the code of the column in one parallel I/O; and a global flag is further outputted that indicates one or more of the following: the number of selected pixels to be exported through the parallel I/O, or whether there is selected pixel to be exported, or the working mode of the data exportation.

In some implementations, wherein the pixel-selection circuitry is configured to select wise pixels according to at least any one of rules: the intensity of a wise pixel is larger than a threshold; or the intensity difference of a wise pixel with the pixel in its neighbouring column is larger than a threshold.

In some implementations, wherein the one or more re-routing circuitries are further configured to: break up data of connected selected wise pixels in a row into one or more unities; and evenly distribute the broken up data of selected wise pixels to the one or more parallel I/Os for data exportation.

In some implementations, wherein the one or more ADCs, are further configured to: for each wise pixel of the one or more wise pixels: generate a flag related to the wise pixel; set the flag to be active if the wise pixel is selected, or set the flag to be non-active if the pixel is not selected; convert the intensity of the wise pixel to digital signals in the case that the flag related to the wise pixel is active.

In some implementations, in a case that the one or more ADCs convert intensities of the selected pixels to digital signal, the image sensor further comprising at least one or more of: one or more of parallel ADCs, configured to AD convert the data corresponding to one parallel I/O simultaneously; and a parallel ADC, configured to output one-bit digital data every cycle until the data is completely converted to digital data, and multiple parallel AD conversion devices, configured to output multiple bits of digital data simultaneously every cycle until the data are completely converted to digital data; and one or more SAR (Successive Approximation Register) ADCs, wherein: the comparators of SAR ADCs are configured to carry out the comparison for selecting wise pixels and AD converting at the same time.

In some implementations, wherein AD converting and data communication use interleaved timing: when the ADC is operating a data, the data in the next row starts to be read out. In some implementations, in case of one or more memory buffers storing the data, wherein: the number of memory buffers is less than the number of pixels corresponding to a same I/O; a CLA logic-based controller controls the data pushing in and shifting out; in case of a FIFO memory, the data is shifted in and shifted out one-bit-by-one-bit; in case of a FIFO memory, a batch of data of multiple bits is shifted in/out in parallel; and data in the memory buffer is emptied when the next intensity is being converted to digital data. In some implementations, wherein the operation timing is controlled by clock signals, and wherein the signal latency is removed by adding buffers; the buffers are in an hierarchical architecture.

Another aspect of the disclosure provides a 3D shape reconstruction method, comprising: calculating a geometry of an object scanned by featured light based on the locations or locations and intensities of selected wise pixels in an image sensor; wherein locations or locations and intensities of selected wise pixels in an image sensor are obtained according to the methods recited by the any of above methods.

In some implementations, wherein calculating a geometry of an object scanned by featured light based on intensities or intensities and locations of selected wise pixels in an image sensor, comprising: forming a pixel ray by a selected wise-pixel and a camera center; intersecting the pixel rays in different image sensors at a point, or intersecting a pixel ray with a surface plan of the light source at a point; and calculating the geometry position of the point according to the calibration information of image sensors.

Another aspect of the disclosure provides an imaging system, comprising: one or more image sensors comprising one or more wise pixels; one or more light sources; one or more computing units coupled with the one or more image sensors; wherein the one or more image sensors are carried out as the image sensors recited above, and the one or more image sensors and the one or more computing units are configured to perform the methods recited by the any of above methods.

This disclosure presents a novel smart complementary metal oxide semiconductor (CMOS) sensor that can detect the “bright” pixels and export the light intensity and location of the selected pixels only. The detecting function is achieved by applying a thresholding criteria method. A novel CMOS architecture is proposed. The FPA-implemented COMS is shared by two sets of column processing circuitry for selecting, processing and exporting the data from top half and bottom half of FPA respectively. To achieve a CMOS with high-speed, low-energy-consuming and high-efficiency, some methods are proposed, Multiple-I/Os-deployment is to reduce the pressure to transfer data in a row; Re-routing scheme is to assign “selected” pixels to I/Os averagely; Temporary Shifting-in-shifting-out memory is to maximize the storage efficiency; Interleaved-timing scheme is to reduce ADC speed requirement.

### BRIEF DESCRIPTION OF THE DRAWINGS

The present disclosure is further described in conjunction with the non-limiting embodiments given by the figures, in which

FIG. 1 shows schematically how the intensities are selected by using the 2-rule strategy according to an embodiment of the present disclosure,

FIG. 2 shows schematically a laser line reflected on the sensor according to an embodiment of the present disclosure,

FIG. 3.1 shows schematically a process for implementing the 2-rules strategy according to an embodiment of the present disclosure,

FIG. 3.2 shows the CMOS architecture for implementing the 2-rules strategy according to an embodiment of the disclosed subject matter.

FIG. 4 shows schematically the overall CMOS architecture according to an embodiment of the present disclosure,

FIG. 5 shows schematically an example of the re-routing scheme according to an embodiment of the present disclosure,

FIG. 6 shows schematically an example of multiple re-routing unities in a row according to an embodiment of the present disclosure,

FIG. 7 shows schematically a scheme of the interleaved timing for ADC and data reading out according to an embodiment of the present disclosure,

FIG. 8 shows schematically the memory buffer which is in a chain architecture and the CLA control circuitry for accessing and shifting the data in the memory buffer according to an embodiment of the present disclosure,

FIG. 9 shows schematically a shift register which shifts in and shifts out data in parallel according to an embodiment of the disclosed subject matter,

FIG. 10 shows schematically a 3D scanning system with a monocular smart image sensor according to an embodiment of the present disclosure, and

FIG. 11 shows schematically a 3D scanning system with dual smart image sensors according to an embodiment of the present disclosure.

### DETAILED DESCRIPTION

In order that those skilled in the art can better understand the present disclosure, the subject matter of the present disclosure is further illustrated in conjunction with figures and embodiments.

The present disclosure relates to a novel smart complementary metal oxide semiconductor (CMOS) sensor for selecting/detecting “bright” pixels according to thresholding criteria on the image plane and output the intensities and locations of the selected pixels only, methods for detecting the pixels meeting the thresholding criteria, encoding the location, reducing the output bandwidth requirements and speeding up ADC so as to achieve high frame rates (>10 k fps), and methods and systems for reconstructing 3D information of objects using the CMOS imaging sensor and structured lights.

### I. Overview

Traditional image sensors output the whole images, which may contain many useless information. For example, in a 3D laser scanner, when a laser line sweeps across the captured objects, the desired information is the location of the bright pixels and their intensities, while the dark pixels shall not be further processed and calculated. In this case, outputting the intensities of dark pixels will lead to high bandwidth requirement and low readout speed of the sensors.

To solve this problem, in this disclosure, we propose a novel smart CMOS image sensor that has the capability of selecting the bright pixels inside the CMOS chip, and outputs the intensities and locations of the selected bright pixels only.

In each frame period, the light illuminated to a pixel is converted a voltage corresponding to the light intensity. The “bright” pixels are selected by the selection circuitry (responsible for selecting pixels whose intensities that meet the thresholding requirements, also described as the column-based comparators in Section III) and only the selected pixels are sent to ADC for data conversion. A fast exporting architecture facilitates data exporting, to evenly distribute the load for data output to the parallel I/Os, the pixels on a row are re-routed to a number of windows or unities and an I/O channel is responsible for outputting intensity and locations of the selected pixels in a window or unity. To reduce the bandwidth requirements, a memory with a fixed length is used to store the data of the selected pixels. A control circuitry is used for controlling the access and storing the data of selected pixels to the memory buffer.

The methods and conceptions in this disclosure has wide applications. For example, it can be applied into 3D scanning, i.e., for high-speed 3D reconstruction of targets in a scene, and tracking of moving objects, etc.

### II. Pixels Selection Methods

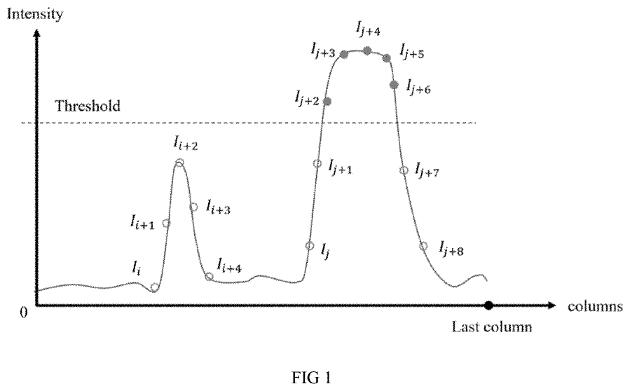

In each frame period, the smart CMOS sensor will not output the intensities of all the pixels. Only the selected intensities and the corresponding pixel locations will be outputted. This section refers to FIGS. 1 to 3.1/3.2 and introduces a method to select the pixels on the CMOS sensor in a frame period.

In some cases, the selection strategy may follow one or both of the following two rules: (1) The intensity of a pixel is larger than a threshold Δ₁; or (2) The difference of intensity of a pixel with its next column (or row) is greater than a threshold Δ₂. If one of the rules is satisfied, the pixel is selected and outputted. The Rule (1) is to detect the peak intensities which may occupy a few pixels in a row when the pixels are saturated. The Rule (2) aims to detect pixels corresponding to the up and down of the intensity curve in a row. As shown in FIG. 1. The Rule (1) detects pixels whose intensities are Iⱼ₊₂, Iⱼ₊₃, Iⱼ₊₄, Iⱼ₊₅, Iⱼ₊₆ (marked by solid circles), while the Rule (2) detects intensities Iⱼ, Iᵢ₊₁, Iᵢ₊₂, Iᵢ₊₃, Iᵢ₊₄, Iⱼ₊ₗ, Iⱼ, Iⱼ₊₁, Iⱼ₊₇, Iⱼ₊₈ which are marked by hollow circles, see in FIG. 1.

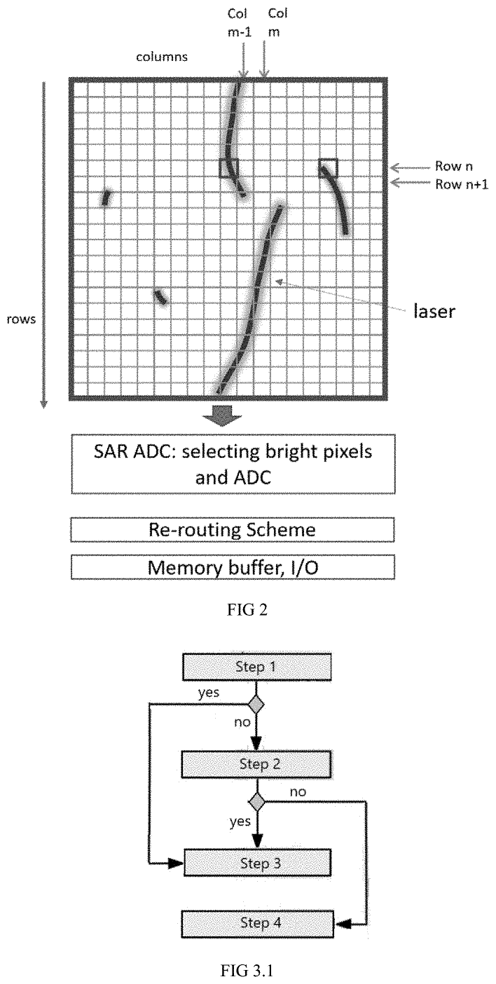

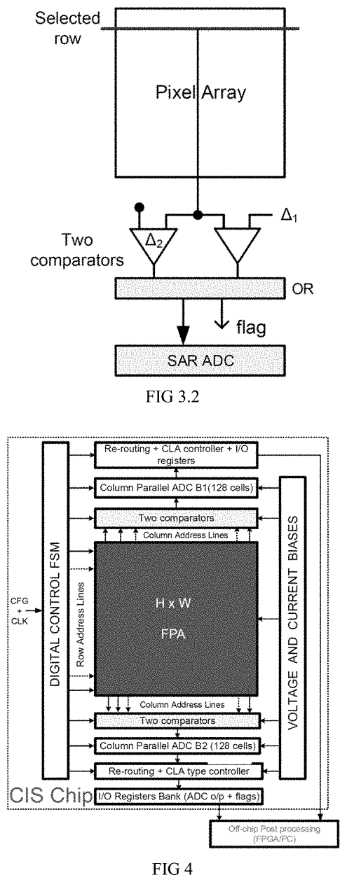

In some cases, the ‘2-rules’ selection process is as follows: (1) When the row n is being processed, check the intensity of each pixel to see if the intensity is larger than the threshold Δ₁ (check if I(n, m)>Δ₁). If yes, go to step (3); If no, do the next step. (2) check the difference of intensities between each pixel and its left pixel to see if the intensity is larger than the threshold Δ₂ (check if |I(n, m)−I(n, m−1)|>Δ₂). If yes, go to step (3); If no, go to step (4). (3) For each selected pixel, a flag is generated, the analog intensity value is steered to the ADC for digital conversion, and then the intensity and the location of the pixel are exported. (4) If row n is not the last row, then process the next row n+1, repeat steps (1)-(3). The architecture for implementing the 2-rules strategy is shown in FIG. 2, FIG. 3.1 and FIG. 3.2. FIG. 3.2 is a diagram example that shows the CMOS architecture for implementing the 2-rules strategy according to an embodiment of the disclosed subject matter.

The thresholds used in a frame period may be manually or adaptively tuned. In some cases, the threshold may be determined according to the background. For example, the threshold can be set as the intensity when the light source is off; or the average intensity of all the pixels in a row (column, or image) when the light source is off.

In each frame period, only the intensities of the selected pixels will be converted to digital signals by ADC to reduce the energy consumption. Then the selected intensities and corresponding pixel locations will be exported.

### III. CMOS Sensor

### 1). CMOS Sensor Architecture

The overall CMOS sensor architecture is shown in FIG. 4. The focal-plane array (FPA) is in the middle of the architecture. The resolution of the FPA is H×W. Here we take 256*256 as an example to explain the disclosure details. On the top and bottom of the FPA, there are two sets of column processing circuitry, each column processing circuitry is responsible for selecting, processing and exporting the data of a half FPA. Such configuration reduces the routing lengths of the row pixels and the requirements for ADC speed.

The column-based comparators are adjacent to the FPA and are responsible for selecting pixels whose intensities that meet the thresholding requirements (see FIG. 4). For each pixel selected by the column-based comparators, a flag is generated and the analog value of the intensity is steered to column parallel SAR (Successive Approximation Register) ADC for digital conversion. It is possible to use the comparator of the SAR ADC to carry out the comparison for selecting the bright pixels and AD converting at the same time. In this case, the comparison can speed up the ADC because the results can be used in the SAR ADC. In other words, the comparison does not cause extra time.

Next, the digital values will be exported to the I/Os and transmitted outside the chip. However, considering the high-speed image output (e.g., 20,000 Hz), large energy and high bandwidth requirements are required to transfer out the flags and ADC data. To overcome this problem, in this disclosure, a novel CMOS architecture is proposed and the details are presented in the following subsections.

### 2). I/O Coding

Suppose there is only 1 I/O in each set of column processing circuitry for transferring out the data of an image whose resolution is H×W(e.g., 2048×2048) and frame rate is f (e.g., 20,000 Hz). Then the output data (d) of a pixel is 19 bits long because 8-bits are necessary for presenting the intensity and 11-bit are needed for encoding its location on a row. Let n be the maximum number of the selected pixels on a row whose intensities meet the 2 rules. Assume that n=48 pixels. The bandwidth requirement for the imaging sensor is H/2×n×f×d=2048/2×48×20000×19=18.68 Gbps, which is too large for a single I/O to cope with. Here the number of row H is divided by 2 because each set of the column processing circuitry is only responsible for processing half of the rows.

In this disclosure, we use multiple I/Os to transfer out the data to speed up the data transmission. By introducing m I/Os, the bandwidth requirement reduces by more than m times. Because the bit length of the output data (d) decreases when the number of I/O channels (m) increases. For example, when 128 I/Os are used, each I/O is responsible for read-outing pixels on 16 columns in a 2048×2048 imager. Then the length of the output data (d) becomes 12 bits, i.e., 8-bits for intensity and 4-bit for addressing the pixels inside the I/O window (2048/128=16 pixels). Therefore, the average bandwidth requirement of each I/O becomes: H/2×n×f×d/m=2048/2×48×20000×12/128=92.16 Mbps if the 48 pixels are evenly distributed among the windows of 128 I/O. Obviously, the 48 pixels will not be evenly distributed in applications. For in example, when the imaging sensor traces a laser beam with a width of 16 pixels, the 16 selected pixels could locate inside the width of a single I/O channel. In this case, the maximum bandwidth of the I/O is /2×n×f×d=2048/2×16×20000×12=3.93 Gbps, which is still too large for a single I/O to cope with. This situation is common when a beam of laser is reflected on the image sensor, where the bright pixels are usually connected. As a result, some I/Os are overburdened. To solve this challenging problem, we invented a re-routing scheme to evenly balance the workload of the parallel I/Os.

### 3). Re-Routing Scheme

Since in actual applications, the selected bright pixels are usually connected to each other, resulting in large bandwidth requirements for an I/O channel even when there are many parallel I/O channels. The objective of the re-routing scheme is to break the data of connected pixels into different new windows and distribute the data equally to the parallel I/Os to facilitate data exporting. The re-routing scheme is shown in FIG. 5. In the scheme, a row is divided into several windows, and each window is composed of multiple connected pixels. Next, the data of connected pixels are broken up and distributed into different new windows, which correspond to I/O pins. For example, FIG. 5 shows 48 pixels that are divided into 3 windows. Using the re-routing scheme, the data of 1st pixel is steered to the 1st place of the 1st new window, the data of 2nd pixel is steered to the 1st place of the 2nd new window, the data of 3rd pixel is steered to the 1st place in the 3rd new window, the data of 4th pixel is steered to the 2nd place of the 1st new window, and so on.

By applying this re-routing scheme, the data of connected pixels (e.g., pixels 6,7,8 and 46,47,48) are broken up and distributed equally to different windows.

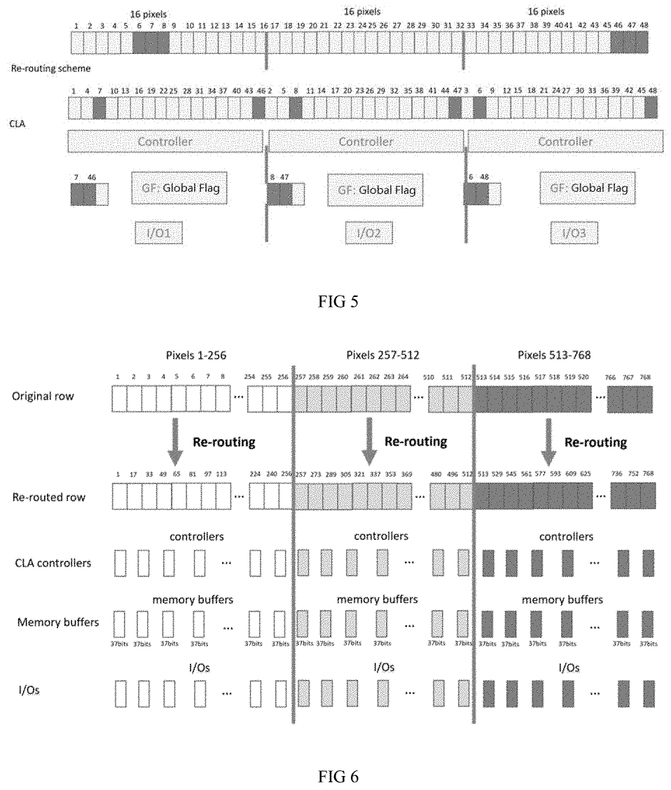

In a row, the pixels re-routed by a unified re-routing scheme forms a re-routing block. A row may be composed of one or more re-routing blocks. In illustrative implementations of this disclosure, FIG. 6 shows a row of an image with 768 columns. The row has 3 re-routing blocks, one of which re-routs pixels on 256 columns. (The pixels in different re-routing blocks are marked with different colour in FIG. 6 for better illustration). Since the architecture of every re-routing block is the same, it is possible to cope the circuity when designing.

### 4). Memory Buffer

Since the CMOS sensor carries out the ADC and outputs the intensity for the selected pixels only, not all of the pixels in a window of a parallel I/O channel need to be sent out. A small memory buffer is added after the window to store the intensities and locations of the selected pixels. The size (length) of the memory buffer (denoted by lₘ) is smaller than the size of a window (l_{w}) because the selected “bright” pixels are evenly distributed by the re-routing circuit. In illustrative implementations of this disclosure, the length of memory for each I/O pin is 3, i.e., the maximum number of the selected bright pixels in a window is 3, and the number in a row is 3×128=384 for an image with 128 I/Os. There is another l_{g}-bit memory for storing a global flag. In illustrative implementations of this invention, the global flag may indicate whether there is any data to be outputted, or/and the number of data to be outputted in the memory buffer. For example, when l_{g}=1, if the flag is 1, there are data to be sent out; otherwise, the memory is empty. When l_{g}=2, the global flag 00, 01, 10 or 11 indicates that there are 0, 1, 2 or 3 data to be outputted via the I/O, respectively. Thus, the bit-length of the memory in each window is lₘ*(bₗ+log₂ l_{w})+l_{g} bits, where bₗ is the depth of the intensities and log₂ l_{w} is the depth of address in a window. In illustrative implementations of this disclosure, the length of memory for each I/O pin is 3, thus the bit-length of the memory buffer in each window is 37 bits (3 pixels*(8-bits intensities+4-bits address)+1-bit global flag). The maximum bandwidth of each I/O is H/2×f×d=2048/2×20000×37=757.76 Mbps (taking 2048 columns and 20 kfps as an example), which can be achieved by conventional FPGA circuitry.

In illustrative implementations of this disclosure, a controller based on the CLA (Carry-lookahead Adder) logic will be used to save the data in a re-routed window to a memory buffer. The enabling logic of the controller is as follows: (1) If the flag of the 1st pixel in a window (marked as flag₁ for convenience) is 1, then the data of the first pixel in the window (ADC₁) is saved to the 1st memory (MEM₁) in the memory buffer; otherwise, (2) if flag₁=0 & flag₂=1, then data of the second pixel in the window (ADC₂) is steered to MEM₁; otherwise (3) if flag₁=0 & flag₂=0 & flag₃=1, then ADC₃ is steered to MEM₁, and so on. Suppose MEM₁ is filled with ADCᵢ, then: (1) if flagᵢ₊₁=1, ADCᵢ₊₁ is steered to the MEM₂; otherwise, (2) if flagᵢ₊₁=0 & flagᵢ₊₂=1, then ADCᵢ₊₂ is steered to MEM₂, and so on. Repeat the process, until the MEM₃ is filled with data or the flag of the last pixel has been checked.

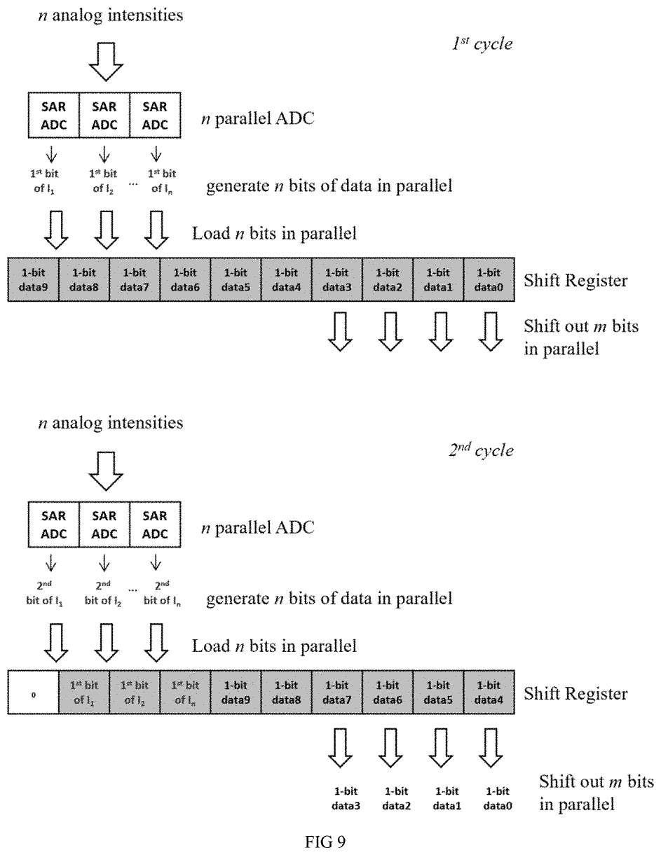

In illustrative implementations of this disclosure, the memory buffer is a FIFO memory and in chain architecture. An example of the architecture is as shown in FIG. 8, where the bit-length of the memory buffer is 37 bits. A controller is utilized to organize the data I/O, shifting in & out because the 3 data coming from the parallel ADCs should be saved in serial. The enabling logic of the controller is as follows: (1) If the flag of the 1st pixel in a window (marked as flag₁ for convenience) is 1, then the data of the first pixel in the window (ADC₁) is steered to the memory buffer, and the controller will generate a signal (Sclk_mem) for shifting in the data ADC₁; otherwise, (2) if flag₁=0 & flag₂=1, then ADC₂ is shifted in to the memory buffer; otherwise (3) if flag₁=0 & flag₂=0 & flag₃=1, then ADC₃ is shifted in to the memory buffer, and so on. Suppose the memory buffer is filled with ADCᵢ, then: (1) if flagᵢ₊₁=1, the controller will generate a ‘Sclk_mem’ signal for shifting outing the data ADCᵢ and shifting in the data ADCᵢ₊₁, otherwise, (2) if flagᵢ₊₁=0 & flag₁₊₂=1, then the controller will generate a ‘Sclk_mem’ signal for shifting outing the data ADCᵢ and shifting in the data ADCᵢ₊₂, and so on. Repeat the process, until the memory buffer is filled with 3 data or the flag of the last pixel has been checked, then the controller generates an I/O enable signal (I/O en) to enable data transmission through I/O. After we have finished processing a row, all the memories will be refreshed, so that when it goes to the next row, the memory will be filled in with new data.

In order to achieve a high-speed frame rate and in case of data loss, the selected pixels' data of a row should be shifted out of the buffer before the data of the next row is shifted in. Thus, the data should be transmitted immediately after ADC. The data includes a global flag (l_{g} bits), the addresses (lₘ×log₂ l_{w} bits) and the intensities (lₘ×bₗ bits). However, the data shifting speed may be affected by the digital data generation. In illustrative implementations of this invention, parallel SAR ADCs are adopted for selecting bright pixels and AD conversion. During that time, the global flag and the addresses can be immediately generated. Then, the SAR ADC starts AD conversion. In each conversion cycle, only 1-bit digital data are generated. When n parallel SAR ADCs are adopted in each I/O window, the n-bit digital data are obtained in each ADC cycle. In illustrative implementations of this invention, a shift register is invented to solve the problem. The shift register operates in a way as follows. In a row processing period, the global flag (l_{g}-bit) and the address are first generated and loaded to the shift register parallelly in the first ADC cycle. Then, in the next cycle, m bits of data are parallelly shifted out and the new-converted n-bit ADC data are shifted in simultaneously, as shown in FIG. 9. Repeating the above process until the final n-bit ADC data are shifted out. The number of out-shifting data (m) should be carefully designed to avoid data overwriting. Suppose the sensor has W columns and the required speed is f fps, the size of the digital data for I/O is lₘ*(bₗ+log₂ l_{w})+l_{g} bits, then, in a unit time, at least

$$\frac{{l}_{m} * ( {b}_{I} + {log}_{2} {l}_{w} ) + {l}_{g}}{Wf}$$

bits of data should be shifted out, i.e. at least

$$\frac{{l}_{m} * ( {b}_{I} + {log}_{2} {l}_{w} ) + {l}_{g}}{Wf} ⨯ {t}_{cycle}$$

bits of data should be buffered out in each cycle, where t_{cycle} is the conversion time for the ADC. The lower bound frequency for shifting is

$$\frac{Wf}{{l}_{m} * ( {b}_{I} + {log}_{2} {l}_{w} ) + {l}_{g}} .$$

### 5). Interleaved Timing

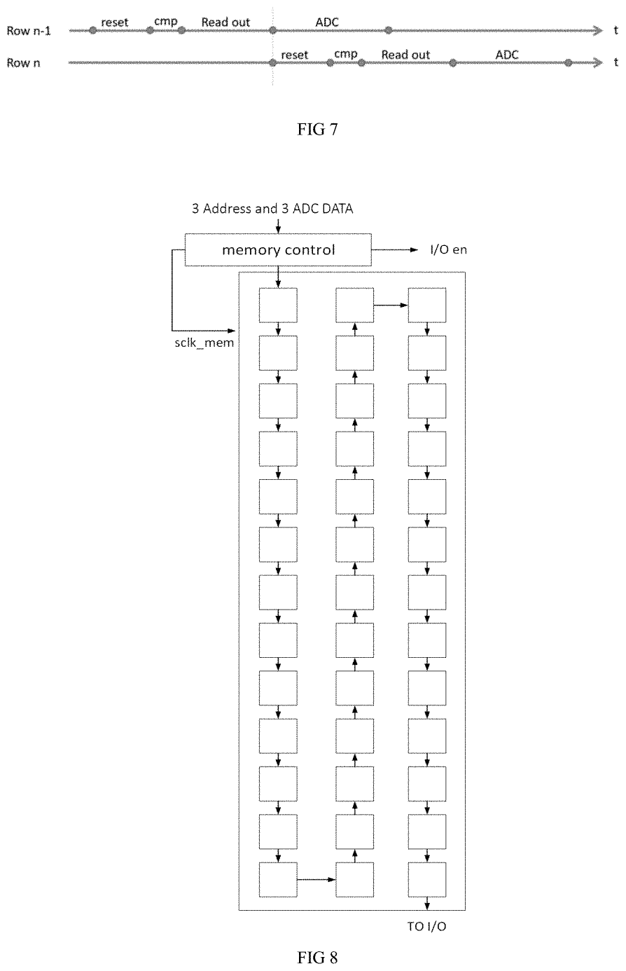

In order to achieve a high-speed frame rate, the total time for row resetting, comparator, data reading out and ADC, should be less than the average row processing time. For example, we have an image array of 2048×2048 with the frame rate of 20,000 Hz, then the average row processing time is 1/(20,000 Hz×2048 rows/2)=48.83 ns. Suppose the time for row resetting, comparator and data reading out is 7.5 ns, 1 ns and 40 ns, respectively. The time left for ADC is only 0.3 ns, which means that the ADC speed is required to be more than 3 GSPS, which is not possible. To reduce the ADC speed requirement, in this disclosure, an interleaved timing is proposed, as illustrated in FIG. 7. In the interleaved timing, reading out data and ADC for each row is not in serial: after the data in row n-1 is read out, the sensor starts to reset the row n; at the same time, the ADC is working on row n-1. By applying this interleaved timing, the speed requirement for ADC is reduced. Therefore, there are 48.83 ns for ADC, thus the ADC speed requirement is reduced to 1/48.83 ns=20.48 MPSP.

The timing signals need to drive and control the operations in a large number of rows and columns, such as row selecting and column-based ADC, etc, which may lead to signal latency and affect the frame rate. To remove the latency, in this disclosure, buffers are added in the signal transition. The buffers are in hierarchical architecture, and the buffers in the lowest level are configured to enable signals of only a few rows or columns. In other words, the signal is sent through the hierarchical buffers, and the buffer is only turned on when the corresponding few rows or columns are selected. This largely reduces the load for the control signal and therefore reduces the latency. For example, in an image sensor with 256 rows, an input signal needs to control the row selecting for 128 rows. By using a four-level hierarchical buffer architecture, the input only needs to drive the row select signals for 16 rows in a given time. At the first instant, the first buffer is turned on and rows 0-15 are ready for selection. Then the buffer is switched off and the next buffer is turned on, so that the input can control the row selection for rows 16 to 31. This process iteratively continues until all rows have been selected.

### IV. 3D Reconstruction Using the Smart CMOS Sensor

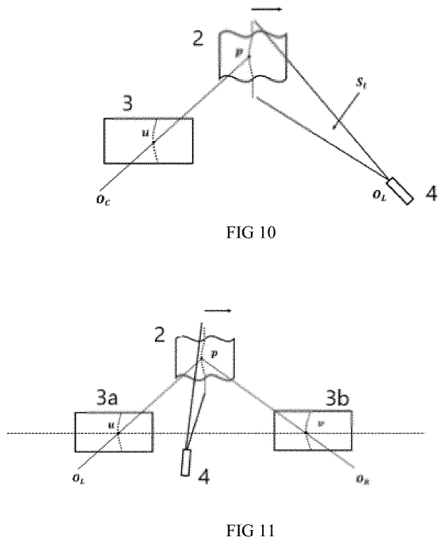

In illustrative implementations of this disclosure, an imaging system includes one or more light sources that illuminates the measured region with featured light, one or more image sensors which comprise multiple wise-pixels, and one or more computing units that calculate the 3D position of the featured light, see in FIGS. 10 and 11.

In illustrative implementations of this disclosure, the light source generated from laser or LED light could be visible or invisible, and the shape of the light source could be chosen in a wide range: a point, a line or a curve. The light generated by the light source could be either a continuous wave or discrete light pulses. The generated light could either scan the measured area or be in a fixed direction. In illustrative implementations, the moving beam or pulses of light can be produced in different methods. For instance, there are several types of light sources that can produce the moving beam or pulses of light: (a) auto-rotated galvanometer; (b) projector; (c) auto-rotated motor. When the light is a moving beam or pulses of light, the angle or position of the light could be measured by the sensor such as an encoder.

In illustrative implementations of this disclosure, the light generated by the light source illuminates the smart image sensors, then the intensities and the location of the illuminated bright pixels are exported to the computing unit using the methods proposed in Section II and Section III.

In illustrative implementations of this disclosure, the computing units are for calculating the 3D shape or 3D profile of the object illuminated by the featured light. At each frame, the intensities and the location of the illuminated bright pixels are obtained, the angle or position of the light can also be obtained from pre-calibration or the sensor (e.g., an encoder), then it is straightforward and simple to calculate the 3D position of the reflection point of the light wave on the object based on triangulation.

In some 3D reconstruction methods of this disclosure, a monocular system that use one smart image sensor shown in FIG. 10 can be used. The light beam scans the measured area, and the angle position of the light beam can be measured by an encoder. The frame update signal of the smart sensor is synchronized with the of the angle update signal of the galvanometer. Therefore, in each frame period, the location of bright pixels and the angle of light beam can be obtained. Then, the direction of the light beam, the wise-pixel, and the optical centre of the camera form a triangulation system, are used to calculate the 3D position of the reflection point of the light beam. As an example, in FIG. 10, a pixel whose location is u is exported as a bright pixel. The surface plane 2 of the incident light St can be determined from the calibration data and the encoder. In the camera model, the center O_{c} of the camera 3 is pre-known. Then the wise-pixel ray O_{c}u may intersect with plane Sₜ at point p. According to the line-surface intersection equation, the 3D position of point p is determined. Therefore, all the exported bright pixels can be calculated to acquire the 3D profile of the illuminated area.

In some implementations, the diagram of a 3D scanning system with dual smart image sensor is shown in FIG. 11. At a frame period, the intensities and location of the bright pixels of the dual sensors can be obtained. For an exported bright pixel u in the left sensor, the corresponding matching pixel v in the right sensor can be found using epipolar geometry. Then the wise-pixel ray O_{L}u and the wise-pixel ray O_{R}v can intersect at point p. According to the line-line intersection equation, the 3D position of point p is determined. Therefore, all the exported bright pixels can be calculated to acquire the 3D profile of the illuminated area.

### Additional Example Embodiments

The following examples are offered as further description of the disclosure:

Example 1. An image sensor comprises one or more multiple wise-pixels that integrate the light intensity during exposures, wherein:
(a) The image sensor selects pixels whose intensities meet certain conditions;
(b) The image sensor exports the locations or locations and intensities of the selected pixels only;
   (c) The image sensor exports data through parallel exporting ports;
   (d) The image sensor uses a fast data transmission architecture so as to achieve a high frame rate.

Example 2. The image sensor of example 1, wherein
the image sensor selects the pixel according to at least any one of rules:
the intensity of a pixel is larger than a threshold; or the intensity difference of a pixel with the pixel in its neighbourhood is larger than a certain threshold.

Example 3. The image sensor of example 1, wherein
the image sensor selects the pixels row by row.

Example 4. The image sensor of example 1, wherein
the image sensor selects the pixels using the column processing circuitry, i.e. one or multiple or all rows in a column share a common processing circuitry, i.e. column processing circuitry; the processing circuitry may include devices such as comparator.

Example 5. The image sensor of example 1, wherein
The image sensor exports data through one or more parallel exporting ports simultaneously (for example, parallel I/Os), and an exporting port is responsible for transmitting the data of one or multiple columns.

Example 6. The image sensor of example 5, wherein
the address only encodes pixels corresponding to one parallel ports.

Example 7. The image sensor of example 1, wherein
only selected pixels' intensities are converted to digital signals.

Example 8. The image sensor of example 7, wherein
(1) a flag is generated and set to be active (i.e. high or 1) if the pixel is selected by the sensor; and a flag is generated and set to be non-active (i.e. low or 0) if the pixel is not selected by the sensor; and
(2) AD conversion operates only when the flag is detected to be active.

Example 9. The image sensor of example 7, wherein
a comparator of the SAR ADC (Successive-approximation Analog-to-Digital Converter) is used to carry out the comparison for selecting bright pixels and AD converting at the same time.

Example 10. The image sensor of example 7, wherein
the AD conversion and data communication use interleaved timing, for example, when AD conversion is operating on a data, the data in the next row starts to be read out.

Example 11. The image sensor of example 7, wherein
one or more of parallel devices (such as parallel ADCs) are responsible for AD conversion of the data corresponding to one parallel data exporting port simultaneously.

Example 12. The image sensor of example 11, wherein
an AD conversion device outputs 1-bit digital data every cycle until the data is completely converted to digital data; n parallel AD conversion devices outputs n-bit digital data every cycle until the data are completely converted to digital data.

Example 13. The image sensor of example 5, wherein
the fast data transmission architecture includes a re-routing circuitry to even distribute the readout load to parallel exporting ports so as to achieve a high frame rate.

Example 14. The image sensor of example 13, wherein
a row of pixels is re-routed so that data of the connected pixels are broken up and distributed to different parallel exporting ports.

Example 15. The image sensor of example 1, wherein
the data are pushed into memory buffers before exporting.

Example 16. The image sensor of example 15, wherein the number of memory buffers is less than the number of pixels corresponding to a same exporting port; the data of the selected pixels are pushed into buffers through a controller which may be based on CLA logic.

Example 17. The image sensor of example 16, wherein
the memory buffer is a FIFO memory and the data is controlled to be shifting in and out the buffer.

Example 18. The image sensor of example 17, wherein the buffer (for example, register) shifts out multiple bits of data as one or more bits of new data are simultaneously shifted in, so that the data are all shifted out when a new batch of pixels is enabled to be proceeded.

Example 19. The image sensor of example 1, wherein the sensor further outputs a global flag that may indicate one or more of the following meanings: the number of selected pixels to be exported, or whether there is selected pixel to be exported, or the working mode of the data exportation.

Example 20. The image sensor of example 1, wherein a clock is generated to synchronize the row selection, AD conversion, or data exportation, etc.

Example 21. The image sensor of example 20, wherein a buffer is added to the clock to remove the delay for high frame rate.

Example 22. A method for high speed 3D shape reconstruction, wherein calculating a geometry of an object scanned by featured light based on the information related to pixel location and/or light intensity, comprising:
a) obtaining the location and/or the intensities of selected wise-pixels in an image sensor recited by any of examples 1-18;
b) forming a pixel ray by a selected wise-pixel and the camera center;
c) intersecting the matching wise-pixel rays in different image sensors at a point, or intersecting a matching wise-pixel ray with a surface plan of the incident light at a point; and
d) calculating the geometry position of the point according to the calibration information of image sensors.

23. An imaging system, comprising:
one or more image sensors recited by any of examples 1-21;
   one or more light sources;
   one or more computing units;
   wherein
   the one or more and the one or more computing units are configured to perform the method recited in example 22.

The description of specific embodiments is only intended to help in understanding the core idea of the present disclosure. It should be noted that the skilled person in the art can make improvements and modifications without departing from the technical principles of the present disclosure. These improvements and modifications should also be considered as the scope of protection of the present disclosure.

1. An imaging method, comprising:
from one or more pixels, selecting pixels according to rules;
outputting the locations or locations and intensities of the selected pixels only;
exporting the data through parallel I/Os; and
facilitating data exporting by a fast exporting architecture.

2. The method of claim 1, before outputting the selected pixels, the method further comprising at least one or more of:
converting the intensities of the selected pixels to digital signals by Analog Digital Converter (ADC);
in case of facilitating data exporting, re-routing the selected pixels on a row by distributing data of the selected pixels into unities; and
storing, in a memory buffer, the data of the selected pixels.

3. The method of claim 1, wherein outputting the selected pixels comprising at least one or more of:
exporting the data from one or more columns by a parallel 1/0, wherein
in a case that the selected pixels are re-routed, the intensities of the selected pixels in a unity are outputted via an I/O channel of the parallel I/Os; and
the location of the selected pixel is the code of the column in one parallel I/O; and
outputting a global flag indicating one or more of the following: the number of selected pixels to be exported through the parallel 1/0, or whether there is selected pixel to be exported, or the working mode of the data exportation.

4. The method of claim 1, wherein selecting pixels according to at least any one of rules:
the intensity of a pixel is larger than a threshold; or
the intensity difference of a pixel with the pixel in its neighbouring column is larger than a threshold, wherein
the threshold is set as a user-defined value, or an intensity when a light source related to the one or more pixels is off, or a average intensity of all pixels in a region when the light source is off, wherein the region is one of:
a row; or
a column; or
an image.

5. The method of claim 2, wherein re-routing the selected pixels on a row by distributing data of the selected pixels into unities comprising:
breaking up data of connected selected wise pixels in a row into one or more unities; and
evenly distributing the broken-up data of selected wise pixels to one or more parallel I/Os for data exportation.

6. The method of claim 2, wherein converting the intensities of the selected pixels to digital signals by ADC comprising at least one or more of:
for each pixel of the one or more pixels:
generating a flag related to the pixel;
setting the flag to be active if the pixel is selected, or setting the flag to be non-active if the pixel is not selected;
converting the intensity of the pixel to digital signals in the case that the flag related to the pixel is active;
AD converting the data corresponding to one parallel I/O simultaneously by one or more of parallel ADCs; and
outputting, by a parallel ADC, one-bit digital data every cycle until the data is completely converted to digital data, and n parallel AD conversion devices outputs n bits of digital data simultaneously every cycle until the data are completely converted to digital data.

7. The method of claim 2, in a case that the ADC is an SAR (Successive Approximation Register) ADC, further comprising:
selecting pixels from the one or more pixels and converting to digital signals by the SAR ADC at the same time.

8. The method of claim 2, wherein AD converting and data communication use interleaved timing: when the ADC is operating a data, the data in the next row starts to be read out.

9. The method of claim 2, wherein storing in a memory buffer the data of the selected pixels comprising at least one or more of:
pushing the data of the pixels corresponding to an I/O to one or more memory buffers, wherein
the number of memory buffers is less than the number of pixels corresponding to a same I/O; and/or
pushing the data of the selected pixels into buffers through a CLA logic-based controller;
in case of a FIFO memory, shifting in/out the data one-bit-by-one-bit; and/or
in case of a FIFO memory, shifting in/out a batch of multiple-bit data in parallel; and
emptying the data in the memory buffer when the next intensity is being converted to digital data.

10. The method of claim 1, further comprising controlling the operation timing by clock signals, and wherein
removing signal latency by adding buffers;
the buffers are in an hierarchical architecture.

11. An image sensor, comprising:
one or more wise pixels in pixel array;
a pixel-selection circuitry coupled with the pixel array, configured to select wise pixels according to rules;
one or more parallel I/Os coupled with the pixel-selection circuitry, configured to output the locations or locations and intensities of the selected wise pixels; and
a fast exporting architecture coupled with the parallel I/Os, configured to facilitate data exporting.

12. The image sensor of claim 11, further comprising at least one or more of:
one or more Analog Digital Converters(ADCs) coupled with the pixel-selection circuitry, configured to convert intensities of the selected pixels to digital signals;
one or more re-routing circuitries in the fast exporting architecture, configured to re-route the selected wise pixels;
one or more memory buffers coupled with the one or more parallel I/Os, configured to store the selected pixels before outputting by the one or more parallel I/Os;
one or more column processing circuitries comprising the pixel-selection circuitry, the one or more parallel I/Os and the fast exporting architecture, wherein
the pixels of one or multiple or all rows in a column are operated using a common column processing circuitry.

13. The image sensor of claim 12, wherein the parallel I/Os further comprising at least one of:
a parallel I/O, configured to export the data from one or more columns, and wherein
in a case that the selected pixels are re-routed, the intensities of the selected pixels in a unity are outputted via an I/O channel of the parallel I/Os; and
the location of the selected pixel is the code of the column in one parallel I/O; and
a global flag is further outputted that indicates one or more of the following: the number of selected pixels to be exported through the parallel I/O, or whether there is selected pixel to be exported, or the working mode of the data exportation.

14. The image sensor of claim 11, wherein the pixel-selection circuitry is configured to select wise pixels according to at least any one of rules:
the intensity of a wise pixel is larger than a threshold; or
the intensity difference of a wise pixel with the pixel in its neighbouring column is larger than a threshold.

15. The image sensor of claim 12, wherein the one or more re-routing circuitries are further configured to:
break up data of connected selected wise pixels in a row into one or more unities; and
evenly distribute the broken-up data of selected wise pixels to the one or more parallel I/Os for data exportation.

16. The image sensor of claim 12, wherein the one or more ADCs, are further configured to:
for each wise pixel of the one or more wise pixels:
generate a flag related to the wise pixel;
set the flag to be active if the wise pixel is selected, or set the flag to be non-active if the pixel is not selected;
convert the intensity of the wise pixel to digital signals in the case that the flag related to the wise pixel is active.

17. The image sensor of claim 12, in a case that the one or more ADCs convert intensities of the selected pixels to digital signal, the image sensor further comprising at least one or more of:
one or more of parallel ADCs, configured to AD convert the data corresponding to one parallel I/O simultaneously;
a parallel ADC, configured to output one-bit digital data every cycle until the data is completely converted to digital data, and multiple parallel AD conversion devices, configured to output multiple bits of digital data simultaneously every cycle until the data are completely converted to digital data; and
one or more SAR (Successive Approximation Register) ADCs, wherein:
the comparators of SAR ADCs are configured to carry out the comparison for selecting wise pixels and AD converting at the same time.

18. The image sensor of claim 12, wherein AD converting and data communication use interleaved timing: when the ADC is operating a data, the data in the next row starts to be read out.

19. The image sensor of claim 12, in case of one or more memory buffers storing the data, wherein:
the number of memory buffers is less than the number of pixels corresponding to a same I/O;
a CLA logic-based controller controls the data pushing in and shifting out;
in case of a FIFO memory, the data is shifted in and shifted out one-bit-by-one-bit;
in case of a FIFO memory, a batch of data of multiple bits is shifted in/out in parallel; and
data in the memory buffer is emptied when the next intensity is being converted to digital data.

20. The image sensor of claim 12, wherein the operation timing is controlled by the clock signals, and wherein
the signal latency is removed by adding buffers;
the buffers are in an hierarchical architecture.

21. A 3D shape reconstruction method, comprising:
calculating a geometry of an object scanned by featured light based on the locations or locations and intensities of selected wise pixels in an image sensor; wherein
the locations or locations and intensities of selected wise pixels in an image sensor are obtained according to methods of claim 1.

22. The 3D shape reconstruction method of claim 19, wherein calculating a geometry of an object scanned by featured light based on intensities or intensities and locations of selected wise pixels in an image sensor, comprising:
forming a pixel ray by a selected wise-pixel and a camera center;
intersecting the pixel rays in different image sensors at a point, or intersecting a pixel ray with a surface plan of the light source at a point; and
calculating the geometry position of the point according to the calibration information of image sensors.

23. An imaging system, comprising:
one or more image sensors comprising one or more wise pixels;
one or more light sources;
one or more computing units coupled with the one or more image sensors;
wherein
the one or more image sensors and the one or more computing units are configured to perform the methods recited by claim 1.
